(19) United States
(12) Patent Application Publication
(10) Pub. No.: US 2005/0110750 A1
(43) Pub. Date: May 26, 2005

(54) Apparatus and method of processing signals

(76) Inventor: Dong-Won Park, Seoul (KR)

Correspondence Address: CANTOR COLBURN, LLP, 55 GRIFFIN ROAD SOUTH, BLOOMFIELD, CT, 06002, US

(21) Appl. No.: 10/997,427

(22) Filed: Nov. 24, 2004

(30) Foreign Application Priority Data
Nov. 26, 2003 (KR) 10-2003-0084535

(51) Int. Cl. H04N 5/202

(52) U.S. Cl. 345/156

(57) ABSTRACT

The signal processing apparatus includes a signal processing portion to receive a first clock and first to third image signals, and generate a second clock, and output corrected image signals with respect to compared results of the first to third image signals; and a frame memory connected to the signal processing portion, and to output the stored first and second image signals to the signal processing portion and to store the third image signals according to the second clock. The signal processing apparatus may reduce costs compared to that of using two or more frame memory and reduce the number of I/O pin of the signal processing apparatus.

### BACKGROUND OF THE INVENTION

1. Field of the Invention

The present invention relates to an apparatus and method of processing signals, more particularly, to a signal processing apparatus using at least one memory to store a plurality of frame image data.

2. Description of the Related Art

Generally, a liquid crystal display device includes two substrates having a plurality of pixel electrode and a common electrode and a liquid crystal layer disposed between them. Such a liquid crystal display device applies certain voltage to the two electrodes to generate an electric field in the liquid crystal layer. And the liquid crystal display device controls transmittance of the light through the liquid crystal layer by adjusting the amplitude of the electric field. As a result, the liquid crystal display device implements desired images. Such a liquid crystal display device is one of flat panel displays, and particularly the liquid crystal display device having a switching element each a pixel is widely used.

Recently, as the user increasingly requires large-scale and high luminance product, it is greatly focused on quality of moving images. In particular, improvement of a response time is an important issue. For this purpose, there has been a technique to apply a data voltage more than a target voltage to the pixel electrode. This needs at least two frame memories capable of storing previous frame data and current frame data. Here, one frame represents a period that scans from one gate line to final gate line. For example, in case of XGA (1024×768), one frame represents a period that scans from 1 to 768.

Therefore, it has been some problems that increase product costs and increase a mounting area of a control board.

### SUMMARY OF THE INVENTION

The present invention provides a signal processing apparatus and method capable of storing three frame data using one frame memory, and also an image display apparatus having the signal processing apparatus.

In one embodiment, a signal processing apparatus includes a signal processing portion to receive a first clock and first to third image signals, and generate a second clock, and output corrected image signals with respect to compared results of the first to third image signals; and a frame memory connected to the signal processing portion, and to output the stored first and second image signals to the signal processing portion and to store the third image signals according to the second clock.

A frequency of the second clock is higher than that of the first clock. The frame memory stores and outputs the first to third image signals during T/3 period (T: 1 frame). The first to third image signals are image signals during 1 frame period, respectively. The corrected image signals are one of overshoot and undershoot image signals. Further, a frequency of the second clock is 1.5 times as high as that of the first clock.

Further, the signal processing portion includes a clock generating portion to receive the first clock, and generate the second clock and a third clock; a first write buffer to store the third image signals according to the third clock, and output the third image signals according to the second clock; a second write buffer to store and output the third image signals according to the third clock; and first and second read buffers to store the first and second image signals according to the second clock, and output the first and second image signals according to the third clock.

The signal processing portion further includes a data correction portion to receive the first to third image signals, and output corrected image signals. A frequency of the third clock is lower than those of the first and second clocks, and a frequency of the second clock is high than that of the first clock. The first write buffer stores the third image signals during T period (T: 1 frame) according to the third clock, and outputs the third image signals during T/3 period according to the second clock. The second write buffer stores the third image signals during T period according to the third clock. The first and second read buffers store the first and second image signals during T/3 period according to the second clock, and output the first and second image signals during T period according to the third clock.

A frequency of the second clock is 1.5 times as high as that of the first clock, and a frequency of the third clock is a ½ frequency of the first clock. The first and second read buffers are line memories, and the first and second write buffers are line memories. The first to third image signals are image signals during 1 frame period. The first write buffer stores the third image signals, and then outputs them after 2T/3 period. The second write buffer stores the third image signals, and then outputs them after T/3 period. The first read buffer stores the first image signals and then outputs them after T/3 period, and the second read buffer stores and outputs them at the same time T/3 period after storing operation of the first read buffer. The first and second read buffers, and the first and second write buffers output the first to third image signals at the same time, respectively.

This application relies for priority upon Korean Patent Application No.2003-84535 filed on Nov. 26, 2003, the contents of which are herein incorporated by reference in its entirety.

### BRIEF DESCRIPTION OF THE DRAWINGS

The above and other features and advantage points of the present invention will become more apparent by describing in detailed embodiments thereof with reference to the accompanying drawings, in which:

FIG. 1 is a block diagram illustrating a liquid crystal display device according to an embodiment of the present invention;

FIG. 2 is an equivalent circuit of one pixel in the liquid crystal display device according an embodiment of the present invention;

FIG. 3 is a block diagram illustrating a signal processing apparatus according an embodiment of the present invention;

FIG. 4 is a view illustrating read/write timing of a frame memory according an embodiment of the present invention;

FIG. 5 is a view illustrating read/write timing of a buffer according an embodiment of the present invention;

FIG. 6 is a timing diagram illustrating read/write data of a first read buffer according to an embodiment of the present invention;

FIG. 7 is a timing diagram illustrating read/write data of a second read buffer according to an embodiment of the present invention;

FIG. 8 is a timing diagram illustrating read/write data of a first write buffer according to an embodiment of the present invention; and

FIG. 9 is a timing diagram illustrating read/write data of a second write buffer according to an embodiment of the present invention.

### DETAILED DESCRIPTION OF THE INVENTION

Hereinafter the embodiments of the present invention will be described in detail with reference to the accompanied drawings.

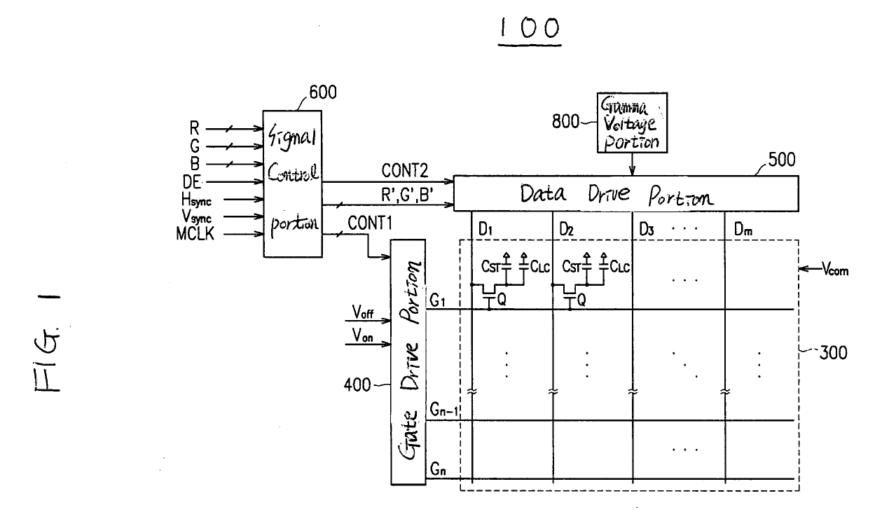

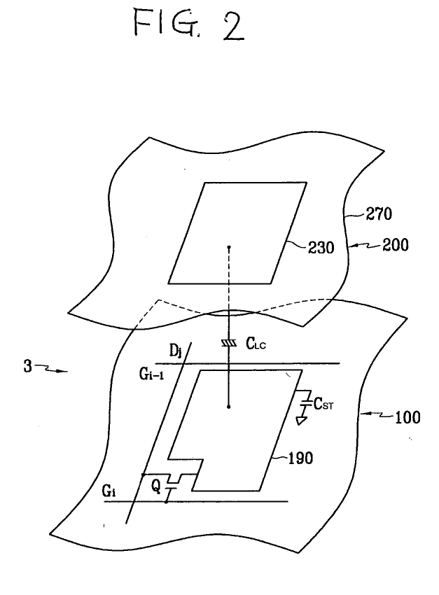

FIG. 1 is a block diagram of a liquid crystal display device according to an embodiment of the present invention, and FIG. 2 is an equivalent circuit of a pixel in the liquid crystal display device according to an embodiment of the present invention.

As shown in FIG. 1, the liquid crystal display device 100 includes a liquid crystal panel assembly 300, a gate drive portion 400, a data drive portion 500, a gamma voltage generating portion 800, and a signal control portion 600.

The liquid crystal panel assembly 300 includes gate lines G1-Gn, data lines D1-Dm, and a plurality of pixels arranged in a matrix. Each pixel has a switching element Q connected to the gate and data line, a liquid crystal capacitor Clc, and a storage capacitor Cst. The storage capacitor Cst may not need as required. The switching element Q is formed on a lower substrate 100 and has three terminal, for example, two terminals are connected the gate and data line, respectively and another terminal is connected to a pixel electrode 190. The liquid crystal capacitor Clc represents a capacitor that a liquid crystal layer 3 is disposed between the pixel electrode 190 and a common electrode 270. The common electrode 270 is formed on an upper substrate 200. Further, the common electrode 270 may be formed on the lower substrate 100. The storage capacitor Cst represents a capacitor that a separate signal line (not shown) formed on the lower substrate 100 overlaps the pixel electrode 190. Further, the storage capacitor Cst may form a capacitor that the pixel electrode 190 overlaps a previous gate line.

The gamma voltage generating portion 800 generates two groups of gamma voltages, for example, one group has higher voltages and another group has lower voltages than a common voltage. The gamma voltage generating portion 800 includes resistors connected to each other and the number of the resistors depends on devices. Further, the gamma voltage generating portion 800 may have IC-typed element.

The gate drive portion 400 includes a plurality of gate drivers and the gate drivers are connected to the gate lines. The gate driver portion 400 applies a gate signal to the gate lines in order to turn on and off the switching elements. Further, the gate drive portion 400 may be formed on the lower substrate 100.

The data drive portion 500 includes a plurality of data drivers and the data drivers are connected to the data lines. The data drive portion 500 applies a desired image signal to the data lines by selecting a certain gamma voltage from the gamma voltage generating portion 800. The gate and data driver may form by attaching a TCP (Tape Carrier Package)(not shown) to the liquid crystal panel assembly 300, or may be mounted on the lower substrate 100, for example, COG (Chip On Glass).

The signal control portion 600 generates control and timing signals and controls the gate drive portion 400 and the data drive portion 500.

Now, it will be in detail explained about operation of the liquid crystal display device with reference to the accompanying drawings. The signal control portion 600 receives an input control signals (Vsync, Hsync, Mclk, DE) from a graphic controller (not shown) and an input image signal (R, G, B) and generates image signals R′, G′, B′, gate control signals CONT1 and data control signals CONT2 with respect to the input control signals and the input image signals. Further, the signal control portion 600 sends the gate control signals CONT1 to the gate drive portion 400 and the data control signals CONT2 to the data drive portion 500. The gate control signals CONT1 include STV informing start of one frame, CPV controlling an output timing of the gate on signal, OE informing an ending time of one horizontal line, etc. The data control signals CONT2 include STH informing start of one horizontal line, TP or LOAD instructing an output of data voltages, RVS or POL instructing polarity reverse of data voltages with respect to a common voltage, etc.

The data drive portion 500 receives the image signals R′, G′, B′ from the signal control portion 600 and outputs the data voltages by selecting gamma voltages corresponding to the image signals R′, G′, B′ according to the data control signals CONT2. The gate driver portion 400 applies the gate on signal according to the gate control signals CONT1 to the gate lines and turns on the switching elements Q connected to the gate lines.

Generally, the liquid crystal display device 100 receives 24 bit or 48 bit data, for example, 8 bit (Red)+8 bit (Green)+8 bit (Blue)=24 bit, from an external graphic controller. In this embodiment, assume that the liquid crystal display device 100 has SXGA resolution (Clock frequency is 108 MHz) and 24 bit R, G, B data. It should be note that the clock frequency and the number of bit depends on the resolution of the display device.

For convenience, the image signals for nth frame Gn indicate the image signals for first frame, the image signals for (n−1)th frame Gn-1 indicate the image signals for second frame, and the image signals for (n−2)th frame Gn-2 indicate the image signals for third frame.

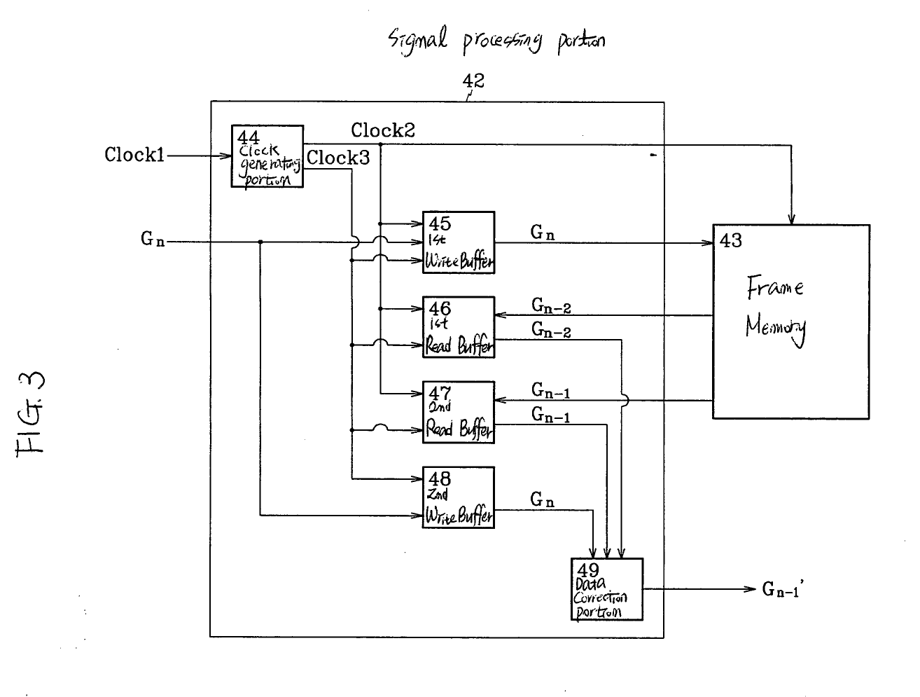

Now, operation of the signal processing apparatus 40 according to the present invention will be in detail described with reference to FIG. 3. The signal processing apparatus 40 may be mounted in the signal control portion 600 in whole or in part.

FIG. 3 is a block diagram of the signal processing apparatus 40 according to an embodiment of the present invention. As shown in FIG. 3, the signal processing apparatus 40 includes a signal processing portion 42 and a frame memory 43. Input and output terminals of the signal processing portion 42 correspond to input and output terminals of the signal processing apparatus 40.

The signal processing portion 42 includes a clock generating portion 44, a first write buffer 45, a first read buffer 46 and a second read buffer 47 that are connected to the clock generating portion 44 and the frame memory 43, respectively, a second write buffer 48 connected to the clock generating portion 44, and a data correction portion 49 connected to the first read buffer 46, the second read buffer 47 and the second write buffer 48.

The clock generating portion 44 generates second and third clocks Clk2 and Clk3 with respect to an external first clock Clk1. As described the above, the first clock Clk1 has the frequency of 108 MHz. The second clock Clk2 has the frequency of 162 MHz being about 1.5 times as high as the first clock Clk1. The third clock Clk3 has the frequency of 54 MHz being about ½ of the first clock Clk1. The second clock Clk2 is 3 times as high as the third clock Clk3. The clock generating portion 44 includes PLL circuit (not shown) for generating the second clock Clk2. The third clock Clk3 may be generated by half dividing the first clock Clk1 by a flip-flop.

The first write buffer 45 writes the image signals for first frame Gn inputted from outside according to the third clock Clk3, and the image signals for first frame Gn is stored in the frame memory 43 according to the second clock Clk2. The second write buffer 48 stores the image signals for first frame Gn according to the third clock Clk3, and the stored image signals for first frame Gn is sent to the data correction portion 49 according to the third clock Clk3.

The first read buffer 46 stores the image signals for third frame Gn-2 stored in the frame memory 43 according to the second clock Clk2, and the image signals for third frame Gn-2 is sent to the data correction portion 49 according to the third clock Clk3. The second read buffer 47 stores the image signals for second frame Gn-1 from the frame memory 43 according to the second clock Clk2, and the stored image signals for second frame Gn-1 is sent to the data correction portion 49 according to the third clock Clk3.

The second write buffer 48 operates by synchronizing with the third clock Clk3 and the first write buffer 45 and the first and second read buffers 46 and 47 operate by synchronizing the second and third clocks Clk2 and Clk3. The first write buffer 45 and the first and second buffers 46 and 47 may implement by using FIFO (First-In-First-Out) or Dual Port RAM. Further, the second write buffer 48 may implement by using the FIFO or the Dual Port RAM. The FIFO and Dual Port RAM has a separated input and output terminals, and thus may input and output image data by synchronizing with a different clock frequency at the input and output terminals.

The data correction portion 49 reads the image signals for first frame Gn from the second write buffer 48, the image signals for second frame Gn-1 from the second read buffer 47, and the image signals for third frame Gn-2 from the first read buffer 46. Further, the data correction portion 49 compares the image signals for first, second and third frames Gn, Gn-1, Gn-2 and outputs a corrected image signals according to the compared result.

The data correction portion 49 may include a data comparing portion (not shown) that compares the image signals for first, second and third frames Gn, Gn-1 and Gn-2 and outputs image signals corresponding to the compared results, at least one Look-Up Table (LUT) (not shown) that stores corrected image signals with respect to the sections of the image signals for first, second and third frames Gn, Gn-1 and Gn-2, and at least one modifier (not shown) that calculates corrected image signals with respect to the image signals from the data comparing portion.

The frame memory 43 may include, for example, DDR SDRAM. The DDR SDRAM may implement read/write operation at rising and falling edges of clock, respectively.

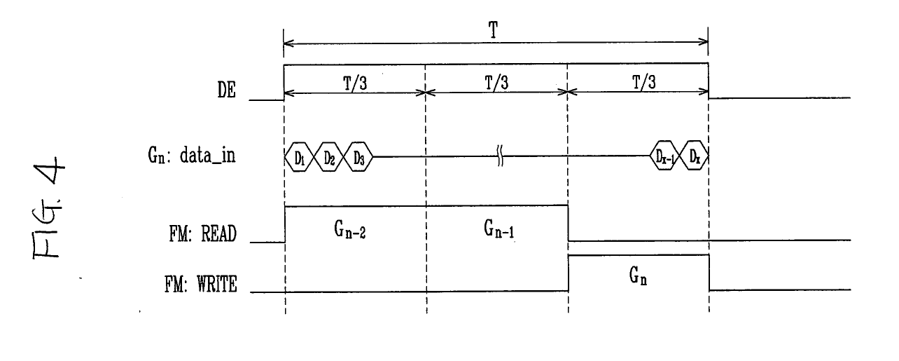

Now, operation of the signal processing apparatus 40 according to the present invention will be in detail described with reference to FIGS. 4 to 9.

In FIGS. 4 to 9, the frame memory 43 represents FM, the first write buffer 45 represents WLM1, the second write buffer 48 represents WLM2, the first read buffer 46 represents RLM1, and the second read buffer 47 represents RLM2.

FIG. 4 is a timing diagram showing read/write operations in the frame memory according to an embodiment of the present invention.

As shown in FIG. 4, the image signals for first frame Gn (data_in) are sent to the signal processing apparatus 40 from an external device (not shown) for a high period of Data Enable T. The image signals for first frame Gn (data_in) is inputted by synchronizing with the first clock Clk1 and is inputted one data per a clock. Herein, one horizontal line data represents D1, D2, . . . , Dx and the data is 24 bit. As described the above, the signal processing portion 42 writes the image signals in the frame memory 43 and reads the image signals from the frame memory 43 by synchronizing with the second clock Clk2. The signal processing portion 42 implements write/read operations of two image signals per a clock. Since the second clock Clk2 is 1.5 times as high as the first clock Clk1, a data processing speed of the signal processing apparatus 40 is 3 times as fast as that of the image signals of first frame Gn (data_in). For example, the signal processing apparatus 40 may implement read/write operations during T/3 period.

The signal processing portion 42 reads the image signals for third frame Gn-2 from the frame memory 43 during T/3 period, and then reads the image signals for second frame Gn-1 from the frame memory 43 during T/3 period, and then writes the image signals for first frame Gn in the frame memory 43 during T/3 period. Further, the signal processing portion 42 may read the image signals for second frame Gn-1 from the frame memory 43 during T/3 period, and then read the image signals for third frame Gn-2 from the frame memory 43 during T/3 period.

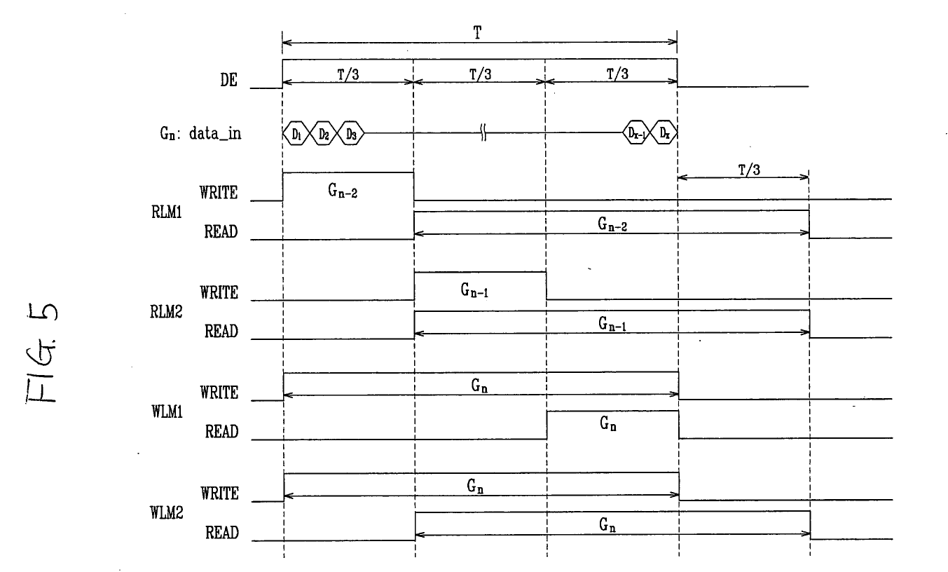

Now, operation of the first and second read buffers 46 and 47, and the first and second write buffers 45 and 48 within the signal processing portion 42 according to an embodiment of the present invention will be in detail with reference to FIG. 5.

FIG. 5 is a timing diagram showing read/write operations in the buffers 45 to 48 according to an embodiment of the present invention.

The signal processing portion 42 reads the image signals for third frame Gn-2 from the frame memory 43 during T/3 period, and then writes them in the first read buffer 46 (RLM1). And the signal processing portion 42 reads the image signals for third frame Gn-2 from the frame memory 43 during T period and sends them to the data correction portion 49. The signal processing portion 42 writes the image signals for third frame Gn-2 in the first read buffer 46 by synchronizing with the second clock Clk2 and reads them by synchronizing with the third clock Clk3.

Further, the signal processing portion 42 reads the image signals for second frame Gn-1 from the frame memory 43 during T/3 period, and writes them in the second read buffer 47 (RLM2). And the signal processing portion 42 reads the image signals for third frame Gn-1 from the frame memory 43 during T period and sends them to the data correction portion 49. The signal processing portion 42 writes the image signals for second frame Gn-1 in the first read buffer 46 by synchronizing with the second clock Clk2 and reads them by synchronizing with the third clock Clk3.

Further, the signal processing portion 42 receives the image signals for second frame Gn from an external device (not shown) during T period, and writes them in the first write buffer 45 (WLM1). And the signal processing portion 42 reads the image signals for first frame Gn from the first write buffer 45 during T/3 period and writes them to the frame memory 43. The signal processing portion 42 writes the image signals for first frame Gn in the first write buffer 45 by synchronizing with the third clock Clk3 and reads them by synchronizing with the second clock Clk2.

Further, the signal processing portion 42 receives the image signals for second frame Gn from an external device (not shown) during T period, and writes them in the second write buffer 48 (WLM2). And the signal processing portion 42 receives the image signals for first frame Gn from the second write buffer 48 during T period and sends them to the data correction portion 49. The signal processing portion 42 writes or reads the image signals for first frame Gn in the second write buffer 48 by synchronizing with the third clock Clk3 and reads them by synchronizing with the second clock Clk2.

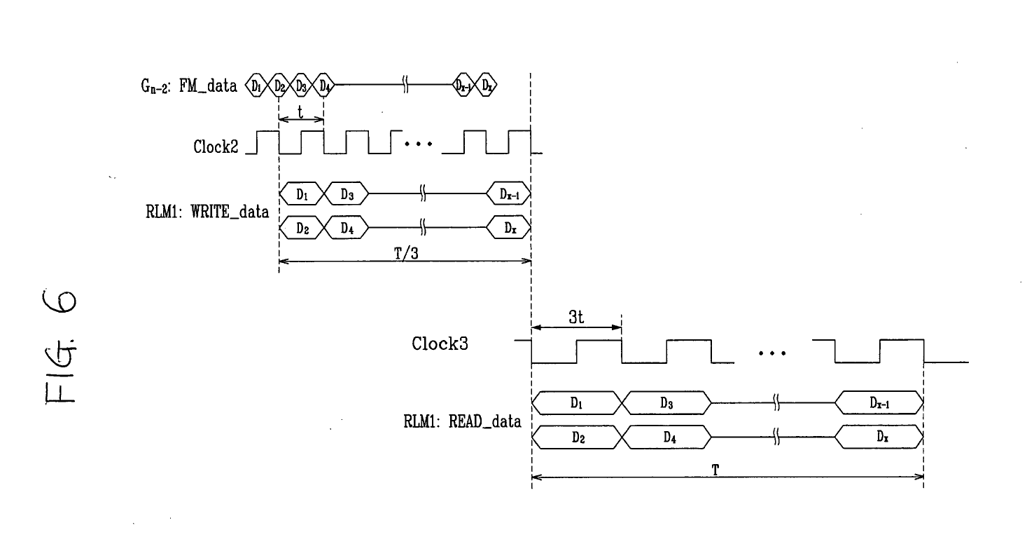

Now, timings of the image signals that are read from or written in the first and second read/write buffers 45 to 48 will be in detail described with reference to FIGS. 6 to 9.

Timings that the image signals are read or written from or in the first read buffer 46 will be described with reference to FIG. 6.

FIG. 6 is a timing diagram showing read/write operations from or in the first read buffer 46 according to an embodiment of the present invention. As shown in FIG. 6, the second clock Clk2 has T period for writing the image signals for third frame Gn-2 in the first read buffer 46 (RLM1) and the third clock Clk3 has 3T period for reading the image signals for third frame Gn-2 from the first read buffer 46 (RLM1). The image signals for third frame Gn-2 (FM_data), for example, 24 bit image signals, are read from the frame memory 43 by synchronizing with rising and falling edges of the second clock Clk2. Meanwhile, the image signals for third frame Gn-2 processed in the first read buffer 46 (RLM1) are 48 bit data that include odd and even data. This may be implemented by a plurality of Flip-Flops. For example, the odd data of the image signals for third frame Gn-2 is latched at a rising edge of the second clock Clk2 and the even data of the image signals for third frame Gn-2 is latched at a falling edge of the second clock Clk2. Then, the latched odd data is delayed by ½ clock, and thus 48 bits data (RLM1:WRITE_data) is generated.

When the signal processing portion 42 writes the image signals in the first read buffer 46 (RLM1), it writes one data per a clock by synchronizing with the second clock Clk2. Therefore, the signal processing portion 42 may process the image signals by the same speed as the frame memory 43. For example, the signal processing portion 42 may write one line data among the image signals for third frame Gn-2 in the first read buffer 46 (RLM1) during T/3 period.

After the write operation, the signal processing portion 42 reads the image signals for third frame Gn-2 from the first read buffer 46 (RLM1) by synchronizing with the third clock Clk3, and then send them to the data correction portion 49. Since the period of the third clock Clk3 is 3T, one line data of the image signals for third frame Gn-2 (RLM1:READ_data) synchronizing with the third clock Clk3 is output during T period.

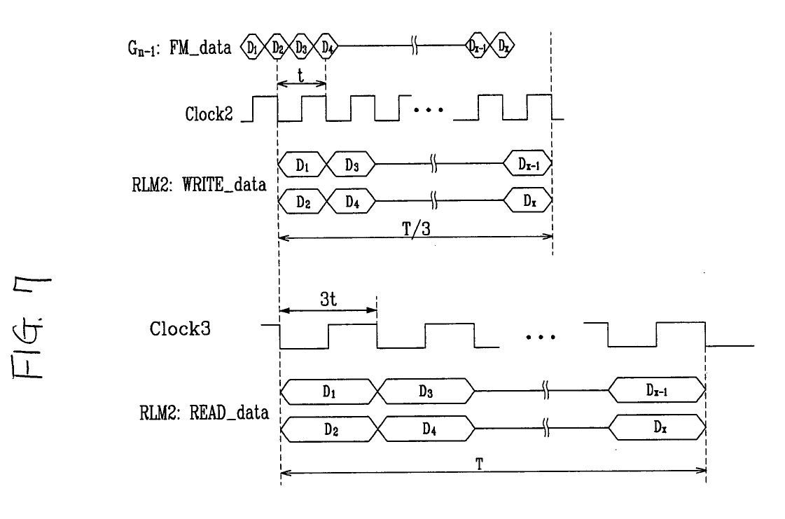

Next, timings that the image signals are read or written from or in the second read buffer 47 will be described with reference to FIG. 7.

FIG. 7 is a timing diagram showing read/write operations from or in the second read buffer 47 according to an embodiment of the present invention. As shown in FIG. 7, timings of the image signals for second frame Gn-1 that are processed in the second read buffer 47 (RLM2) are the same as those processed in the first read buffer 46 (RLM1). However, the signal processing portion 42 reads the image signals for second frame Gn-1 from the frame memory 43 during T/3 period and writes them in the second read buffer 47 (RLM2). Therefore, the descriptions of the second read buffer 47 (RLM2) will be omitted.

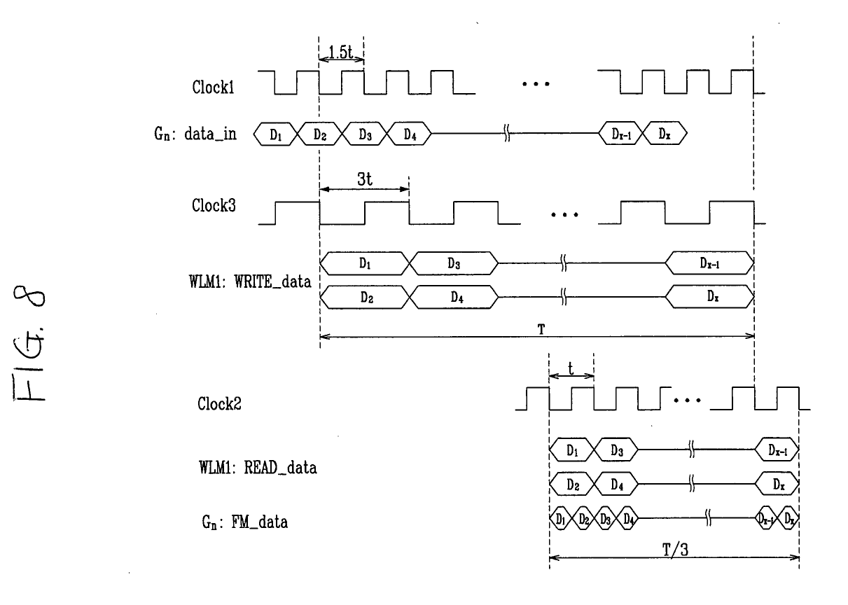

Next, timings that the image signals are read or written from or in the second read buffer 47 will be described with reference to FIG. 8. Gn-2 is latched at a falling edge of the second clock Clk2. Then, the latched odd data is delayed by ½ clock, and thus 48 bits data (RLM1:WRITE_data) is generated.

When the signal processing portion 42 writes the image signals in the first read buffer 46 (RLM1), it writes one data per a clock by synchronizing with the second clock Clk2. Therefore, the signal processing portion 42 may process the image signals by the same speed as the frame memory 43. For example, the signal processing portion 42 may write one line data among the image signals for third frame Gn-2 in the first read buffer 46 (RLM1) during T/3 period.

After the write operation, the signal processing portion 42 reads the image signals for third frame Gn-2 from the first read buffer 46 (RLM1) by synchronizing with the third clock Clk3, and then send them to the data correction portion 49. Since the period of the third clock Clk3 is 3T, one line data of the image signals for third frame Gn-2 (RLM1:READ_data) synchronizing with the third clock Clk3 is output during T period.

Next, timings that the image signals are read or written from or in the second read buffer 47 will be described with reference to FIG. 7.

FIG. 7 is a timing diagram showing read/write operations from or in the second read buffer 47 according to an embodiment of the present invention. As shown in FIG. 7, timings of the image signals for second frame Gn-1 that are processed in the second read buffer 47 (RLM2) are the same as those processed in the first read buffer 46 (RLM1). However, the signal processing portion 42 reads the image signals for second frame Gn-1 from the frame memory 43 during T/3 period and writes them in the second read buffer 47 (RLM2). Therefore, the descriptions of the second read buffer 47 (RLM2) will be omitted.

Next, timings that the image signals are read or written from or in the second read buffer 47 will be described with reference to FIG. 8.

FIG. 8 is a timing diagram showing read/write operations from or in the second read buffer 47 according to an embodiment of the present invention. As described the above, the signal processing portion 42 receives the image signals for first frame Gn (data_in) by synchronizing with the first clock Clk1 and writes them in the first write buffer 45 (WLM1) by synchronizing with the third clock Clk3, and reads them from the first write buffer 45 (WLM1) by synchronizing with the second clock Clk2.

The signal processing portion 42 reads the image signals for first frame Gn from the first write buffer 45 (WLM1) during T/3 period by synchronizing with the second clock Clk2. Therefore, the signal processing portion 42 may read the image signals during T/3 period. Since the image signals for first frame Gn (WLM1:READ_data) are 48 bits, the signal processing portion 42 transfers the image signals into 24 bits of the image signals and then sends the transferred image signals to the frame memory 43. This may be implemented by using multiplexer (not shown). For example, the 48 bits of the image signals are connected to the input terminal of the multiplexer by 24 bits and the second clock Clk2 is connected to a selector (not shown). 24 bits of odd data are outputted at a low level of the second clock Clk2 and 24 bits of even data are outputted at a high level of the second clock Clk2. Therefore, as shown in FIG. 8, one data per ½ clock of the second clock Clk2 is sent to the frame memory 43.

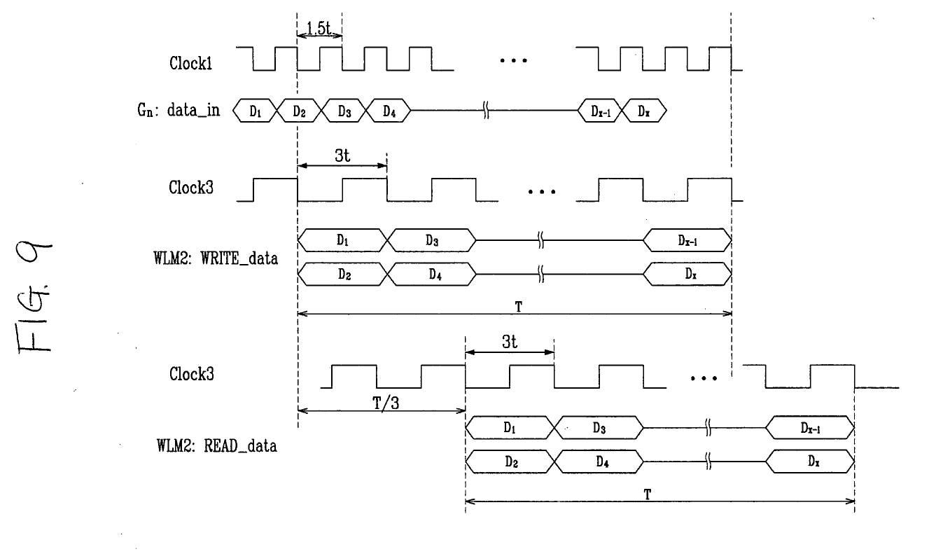

Next, timings that the image signals are read or written from or in the second write buffer 48 will be described with reference to FIG. 9.

FIG. 9 is a timing diagram showing read/write operations from or in the second write buffer 48 according to an embodiment of the present invention. As described the above, the signal processing portion 42 substantially, simultaneously writes the image signals for first frame Gn in the first and second write buffers 45 and 48 (WLM1 and WLM2). Therefore, timings of the image signals for first frame Gn that are written in the second write buffer 48 (WLM2) is the same as those that are written in the first write buffer 45 (WLM1).

While the signal processing portion 42 writes the image signals for first frame Gn in the second write buffer 48 (WLM2), it reads the image signals for first frame Gn from the second write buffer 48 (WLM2) by synchronizing with the third clock Clk3 after T/3 period. And then, the signal processing portion 42 sends the image signals to the data correction portion 49. Since a period of the third clock is 3T, one horizontal line data of the image signals for first frame Gn (WLM2:READ_data) is outputted during T period. The image signals for first, second and third frames Gn, Gn-1 and Gn-2 are synchronized with the third clock Clk3.

The data correction portion 49 receives the image signals for first, second and third frames Gn, Gn-1 and Gn-2 from the first to second read buffer 45 and 46 (RLM1 and RLM2) and the second write buffer 48 (WLM2). Further, the data correction portion 49 compares them and generates corrected image signals Gn′ according the compared results.

Therefore, the present invention may compare the image signals for 3 frames and generate corrected image signals according the compared results by using one frame memory. As a result, the present invention may reduce costs compared to that of using two or more frame memory and reduce the number of I/O pin of the signal processing apparatus. Further, the present invention may greatly reduce the mounting area that pluralities of frame memories occupy.

The present invention has been described with reference to the embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A signal processing apparatus, comprising:
a signal processing portion to receive a first clock and first to third image signals, and generate a second clock, and output corrected image signals with respect to compared results of the first to third image signals; and
a frame memory to output the stored first and second image signals to the signal processing portion and to store the third image signals according to the second clock.

2. The signal processing apparatus of claim 1, wherein a frequency of the second clock is higher than that of the first clock.

3. The signal processing apparatus of claim 2, wherein the frame memory stores and outputs the first to third image signals during T/3 period (T: 1 frame).

4. The signal processing apparatus of claim 3, wherein the first to third image signals are image signals during 1 frame period, respectively.

5. The signal processing apparatus of claim 1, wherein the corrected image signals are one of overshoot and undershoot image signals.

6. The signal processing apparatus of claim 2, wherein a frequency of the second clock is 1.5 times as high as that of the first clock.

7. The signal processing apparatus of claim 1, wherein the signal processing portion comprises
a clock generating portion to receive the first clock and to generate the second clock and a third clock;
a first write buffer to store the third image signals according to the third clock, and to output the third image signals according to the second clock;
a second write buffer to store and to output the third image signals according to the third clock; and
first and second read buffers to store the first and second image signals according to the second clock, and to output the first and second image signals according to the third clock.

8. The signal processing apparatus of claim 7, the signal processing portion further comprises a data correction portion to receive the first to third image signals, and to output corrected image signals.

9. The signal processing apparatus of claim 8, wherein a frequency of the third clock is lower than those of the first and second clocks, and a frequency of the second clock is high than that of the first clock.

10. The signal processing apparatus of claim 9, wherein the first write buffer stores the third image signals during T period (T: 1 frame) according to the third clock, and outputs the third image signals during T/3 period according to the second clock.

11. The signal processing apparatus of claim 10, wherein the second write buffer stores the third image signals during T period according to the third clock.

12. The signal processing apparatus of claim 11, wherein the first and second read buffers store the first and second image signals during T/3 period according to the second clock, and output the first and second image signals during T period according to the third clock.

13. The signal processing apparatus of claim 12, wherein a frequency of the second clock is 1.5 times as high as that of the first clock, and a frequency of the third clock is a ½ frequency of the first clock.

14. The signal processing apparatus of claim 13, wherein the first and second read buffers and the first and second write buffers are line memories.

15. The signal processing apparatus of claim 14, wherein the first to third image signals are image signals during 1 frame period.

16. The signal processing apparatus of claim 15, wherein the first write buffer stores the third image signals, and then outputs them after 2T/3 period.

17. The signal processing apparatus of claim 16, wherein the second write buffer stores the third image signals, and then outputs them after T/3 period.

18. The signal processing apparatus of claim 17, wherein the first read buffer stores the first image signals and then outputs them after T/3 period, and the second read buffer stores and outputs them at the same time T/3 period after storing operation of the first read buffer.

19. The signal processing apparatus of claim 18, wherein the first and second read buffers, and the first and second write buffers output the first to third image signals at the same time, respectively.

20. A method of processing signals, comprising:
receiving a first clock and first to third image signals;
generating a second clock according to the first clock;
reading the first and second image signals from a frame memory;
storing the third image signals in the frame memory, and
outputting corrected image signals with respect to compared results of the first to third image signals.

21. The method of claim 20, wherein a frequency of the second clock is higher than that of the first clock.

22. The method of claim 21, wherein the frame memory is performed during T/3 period (T: 1 frame).

23. The method of claim 22, wherein the first to third image signals are image signals during 1 frame period, respectively.

24. The method of claim 20, wherein the corrected image signals are one of overshoot and undershoot image signals.

25. The method of claim 21, wherein the frequency of the second clock is 1.5 times as high as that of the first clock.
